(19) United States
(12) Patent Application Publication
(10) Pub. No.: US 2026/0074993 A1
(43) Pub. Date: Mar. 12, 2026

(54) COMMUNICATION SYSTEM AND COMMUNICATION METHOD

(71) Applicant: ASMedia Technology Inc., New Taipei City (TW)

(72) Inventors: Wen-Cheng Chen, New Taipei City (TW); Iuan-Tsung Cheng, New Taipei City (TW); Ming-Han Hsu, New Taipei City (TW)

(73) Assignee: ASMedia Technology Inc., New Taipei City (TW)

(21) Appl. No.: 18/922,438

(22) Filed: Oct. 22, 2024

(30) Foreign Application Priority Data
Sep. 11, 2024 (TW) 113134431

(51) Int. Cl. H04L 45/741

(52) U.S. Cl. CPC H04L 45/741

(57) ABSTRACT

Provided is a communication system and a communication method. The communication system includes multiple field programmable gate array (FPGA) devices. Each of the FPGA devices is electrically connected to another one of the FPGA devices. A first FPGA device is configured to determine a format of a packet. When the format of the packet belongs to a first transmission format or a second transmission format, the first FPGA device adds a routing information to the packet and transmits the packet to a second FPGA device.

### CROSS-REFERENCE TO RELATED APPLICATION

This application claims the priority benefit of Taiwan application serial no. 113134431, filed on Sep. 11, 2024. The entirety of the above-mentioned patent application is hereby incorporated by reference herein and made a part of this specification.

### BACKGROUND

### Technical Field

The disclosure relates to a transmission method between multiple field programmable gate array devices and a transmission system including multiple field programmable gate array devices.

### Description of Related Art

In the existing technology, field programmable gate arrays (FPGAs) are often used to efficiently perform specific computing tasks and are widely applied in fields such as embedded systems and digital signal processing. When circuits are to be developed, a FPGA may often be used first for verification. However, as system complexity increases, the computing power and resource configuration of a single FPGA might not be able to meet the requirements, so that designers choose multiple FPGAs to work together to share the computational load. However, in a multi-FPGA system, data transmission and communication face significant challenges. Current solutions provide transmission protocols between two FPGAs. These protocols are not scalable enough and may become difficult to manage when the number of FPGAs increases.

### SUMMARY

The disclosure proposes a communication system and a communication method that are adapted for multiple field programmable gate array (FPGA) devices. Through adding a routing information to a packet, the packet may be transmitted to any one of the FPGA devices.

An embodiment of the disclosure provides a communication system that includes multiple field programmable gate array (FPGA) devices. Each of the FPGA devices includes at least one connection port, and each of the FPGA devices is electrically connected to another one of the FPGA devices through the corresponding connection port. The FPGA devices include a first FPGA device and a second FPGA device. The first FPGA device is configured to determine a format of a packet, and the format belongs to one of multiple transmission formats. When the format belongs to a first transmission format or a second transmission format, the first FPGA device adds a routing information to the packet and transmits the packet to the second FPGA device.

In an embodiment, the routing information includes a bus sequence number, a device sequence number, and a function sequence number. The bus sequence number corresponds to the second FPGA device, the device sequence number corresponds to the connection port of the second FPGA device, and the function sequence number corresponds to one of multiple modules in the second FPGA device.

In an embodiment, the FPGA devices include a third FPGA device. The third FPGA device is electrically connected between the first FPGA device and the second FPGA device. The third FPGA device receives the packet and transmits the packet to the second FPGA device based on the routing information.

In an embodiment, a number of the connection port of the second FPGA device is greater than one, and the device sequence number corresponds to one of the connection ports.

In an embodiment, when the format belongs to the first transmission format, the first FPGA device transmits the packet in a non-post manner. When the format belongs to the second transmission format, the first FPGA device sets the packet as a vender message and transmits the packet in a post manner.

In an embodiment, when the format belongs to a third transmission format among the transmission formats, the first FPGA device sets the packet to be transmitted to the second FPGA device in a memory writing manner.

In an embodiment, the first FPGA device is electrically connected to the second FPGA device, the packet includes an address, and the second FPGA device provides the packet to one of multiple modules in the second FPGA device.

From another perspective, an embodiment of the disclosure provides a communication method that is adapted for multiple field programmable gate array (FPGA) devices. The communication method includes: a format of a packet is determined by a first FPGA device. The format belongs to one of multiple transmission formats. Each of the FPGA devices includes at least one connection port, and each of the FPGA devices is electrically connected to another one of the FPGA devices through the corresponding connection port. The communication method further includes: a routing information is added to the packet, and the packet is transmitted to a second FPGA device by the first FPGA device when the format belongs to a first transmission format or a second transmission format.

In an embodiment, the communication method further includes: the packet is received and transmitted to the second FPGA device based on the routing information by the third FPGA device.

In an embodiment, the communication method further includes: the packet is transmitted in a non-post manner by the first FPGA device when the format belongs to the first transmission format; and the packet is set as a vender message and transmitted in a post manner by the first FPGA device when the format belongs to the second transmission format.

In an embodiment, the communication method further includes: the packet is set to be transmitted to the second FPGA device in a memory writing manner by the first FPGA device when the format belongs to a third transmission format among the transmission formats.

In an embodiment, the packet includes an address, and the communication method further includes: the packet is provided to one of multiple modules in the second FPGA device based on the address by the second FPGA device.

In order to make the features and advantages of the disclosure more comprehensible, the following examples are given and described in detail with the accompanying drawings as follows.

### BRIEF DESCRIPTION OF THE DRAWINGS

FIG. 1 is a schematic diagram of a communication system according to an embodiment.

FIG. 2 is a schematic diagram of data in different layers according to an embodiment.

FIG. 3 is a schematic diagram of packet transmission between various FPGA devices according to an embodiment.

FIG. 4 is a flow chart of a communication method according to an embodiment.

### DESCRIPTION OF THE EMBODIMENTS

Some embodiments of the disclosure will be described in detail below with reference to the accompanying drawings. The reference numerals cited in the following description will be regarded as the same or similar elements when the same reference numerals appear in different drawings. The embodiments are merely part of the disclosure and do not disclose all possible implementations of the disclosure. More specifically, the embodiments are merely examples of systems and methods in the scope of the disclosure.

The terms “first”, “second”, etc. used in the disclosure do not specifically refer to the sequence or order, but are only used to distinguish elements or operations described with the same technical terms.

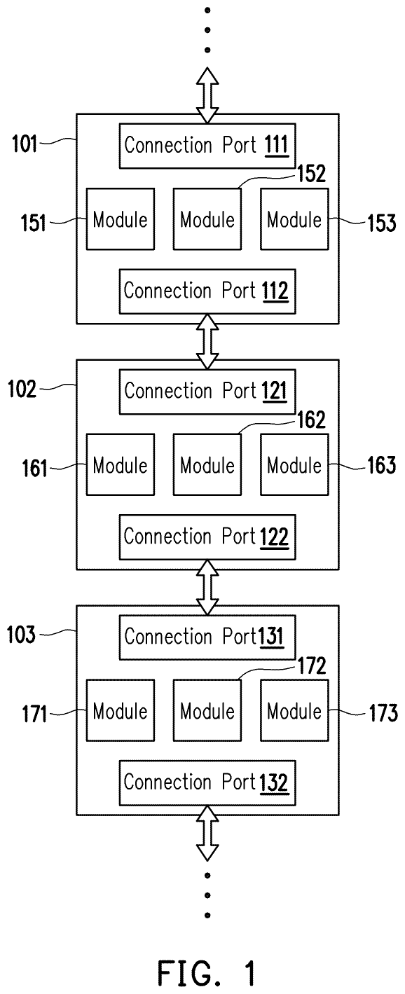

FIG. 1 is a schematic diagram of a communication system according to an embodiment. Please refer to FIG. 1. The communication system includes multiple field programmable gate array (FPGA) devices 101 to 103. Each of the FPGA devices 101 to 103 includes at least one connection port. For example, the FPGA device 101 includes connection ports 111 and 112; the FPGA device 102 includes connection ports 121 and 122; and the FPGA device 103 includes connection ports 131 and 132. Each of the FPGA devices is electrically connected to another one of the FPGA devices. In the embodiment of FIG. 1, the FPGA device 101 is electrically connected to the FPGA device 102, and the FPGA device 102 is electrically connected to the FPGA device 103. However, the FPGA device 101 may also be electrically connected to other FPGA devices through the connection port 111, or the FPGA device 103 may also be electrically connected to other FPGA devices through the connection port 132. The disclosure does not limit the number and the connection method of FPGA devices and does not limit the number of connection ports on each of the FPGA devices either.

Each of the FPGA devices 101 to 103 has one or multiple modules. Each module has multiple logic gates configured to implement specific functions. For example, the FPGA device 101 includes modules 151 to 153; the FPGA device 102 includes modules 161 to 163; the FPGA device 103 includes modules 171 to 173. However, the disclosure does not limit the number of modules included in each of the FPGA devices.

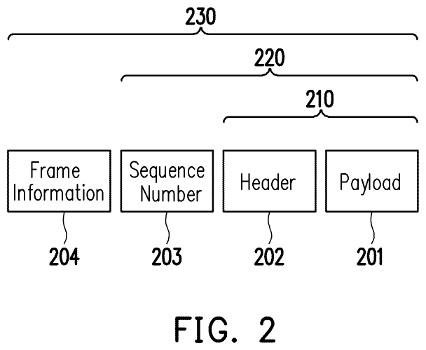

A general FPGA device may provide a transmission interface of a physical layer, but users need to define a data link layer and a transaction layer on their own. In the embodiment, at least three transmission formats of a packet are designed in the transaction layer. Some transmission formats have routing information and may transmit packets to any one of the FPGA devices in the entire system. One transmission format is adapted to transmit data between two FPGA devices. FIG. 2 is a schematic diagram of data in different layers according to an embodiment. Please refer to FIG. 1 and FIG. 2. A packet of a transaction layer 210 includes a payload 201 and a header 202. The foregoing routing information is in the header 202. In a data link layer 220, a sequence number 203 may be further added to the packet. In a physical layer 230, a frame information 204 may be further added to form a frame. In other embodiments, the transaction layer 210, the data link layer 220 and the physical layer 230 may further include other data, such as error correction codes, but the disclosure is not limited thereto.

Each connection port has a buffer configured to temporarily store received (or transmitted) frames, and the sequence number 203 may be configured to prevent the buffer from overflowing. For example, when a first FPGA device transmits a frame to a second FPGA device, the second FPGA device may transmit an acknowledge frame to the first FPGA device based on the sequence number (indicated as a positive integer N) in the frame. The sequence number in the acknowledge frame is also N. After the first FPGA device receives the acknowledge frame, it indicates that the second FPGA device has indeed received the frame with the sequence number N, and may delete the corresponding frame in the buffer. The sequence number N may be used to transmit other frames.

On the other hand, the header 202 has information about the transmission format. The format of the packet may be determined based on the information. A total of three transmission formats are formulated in the embodiment, and each of the transmission formats will be described below.

When the format of a packet belongs to a first transmission format, an FPGA device transmits the packet in a non-post manner. That is to say, the transmitter needs to wait for packet completion of the receiver after transmitting a request in order to continue with subsequent operations. For example, when an FPGA device wants to read data on another FPGA device, a packet of the first transmission format may be used. In some embodiments, when a central processor is to access an external register, a packet of the first transmission format may also be used.

A packet in the first transmission format has a routing information that records identification information of the receiver. For example, the routing information includes a bus sequence number, a device sequence number, and a function sequence number. The routing information is also called a BDF information. The bus sequence number corresponds to an FPGA device, the device sequence number corresponds to a connection port, and the function sequence number corresponds to a module. Each FPGA device has a unique bus sequence number, and different connection ports on the same FPGA device have different device sequence numbers, and different modules on the same FPGA device have different function sequence numbers. For example, the bus sequence number of the FPGA device 101 is “0”; the bus sequence number of the FPGA device 102 is “1”; and the bus sequence number of the FPGA device 103 is “2”. In addition, the device sequence number of the connection port 111 is “0”; the device sequence number of the connection port 112 is “1”; the device sequence number of the connection port 121 is “0”; the device sequence number of the connection port 122 is “1”; the device sequence number of the connection port 131 is “0”; the device number of the connection port 132 is “0”. The function sequence numbers of the modules 151 to 153 are respectively “0”, “1”, and “2”; the function numbers of the modules 161 to 163 are respectively “0”, “1”, and “2”; the function numbers of the modules 171 to 173 are respectively “0”, “1”, and “2”.

When the FPGA device 101 is to transmit a packet to the connection port 131 on the FPGA device 103 and set the module 172 to receive the packet, the routing information may be set as (2,0,1). The three numbers respectively indicate a bus sequence number, a device sequence number, and a function sequence number. Since the FPGA device 101 is not directly electrically connected to the FPGA device 103, and the FPGA device 102 is electrically connected between the FPGA device 101 and the FPGA device 103. Therefore, the packet may be sent to the FPGA device 102 first. The FPGA device 102 may check the routing information in the packet and determine that the packet is to be sent to the FPGA device 103. The packet is transmitted to the FPGA device 103 based on the routing information. The packet may be temporarily stored in the buffer in the connection port 131. Next, the module 172 may obtain the packet from the buffer in the connection port 131.

When the format of a packet belongs to a second transmission format, the packet is transmitted in a post manner. In other words, the transmitter does not need to wait for the confirmation or packet completion of the receiver before continuing with other operations. For example, when an FPGA device is to write data to other FPGA devices, a packet of the second transmission format may be used. When an FPGA device is to transmit some information that does not frequently change, such as information indicating the current status, a packet of the second transmission format may also be used. In some embodiments, packets in the second transmission format may also be set as vender messages. Similar to the first transmission format, a packet of the second transmission format also has a routing information. The routing information has been described above and will not be repeated here.

When the format of a packet belongs to a third transmission format, the FPGA device sets the packet to be sent to other FPGA devices in a memory writing manner. In some embodiments, the address space of a transaction layer at least includes a memory type and a message type. The foregoing first transmission format and second transmission format use the message type, and the third transmission format uses the memory type. Therefore, the packet of the third transmission format does not have any routing information but has an address. When the packet is transmitted to the buffer of a connection port in an FPGA device, the FPGA device may provide the packet to the corresponding module. For example, each module may check the address in the packet. If the address belongs to the address range of the module itself, the module may accept the packet. The third transmission format is adapted for two FPGA devices that are electrically connected to each other, such as packets that may exchange the third transmission format between the FPGA devices 101 and 102, or between the FPGA devices 102 and 103. Compared with the conventional technology using single data rate (SDR) or double data rate (DDR), the third transmission format may achieve a higher transmission speed. In some embodiments, when a large amount of data is to be transmitted between two FPGA devices, the third transmission format may be used.

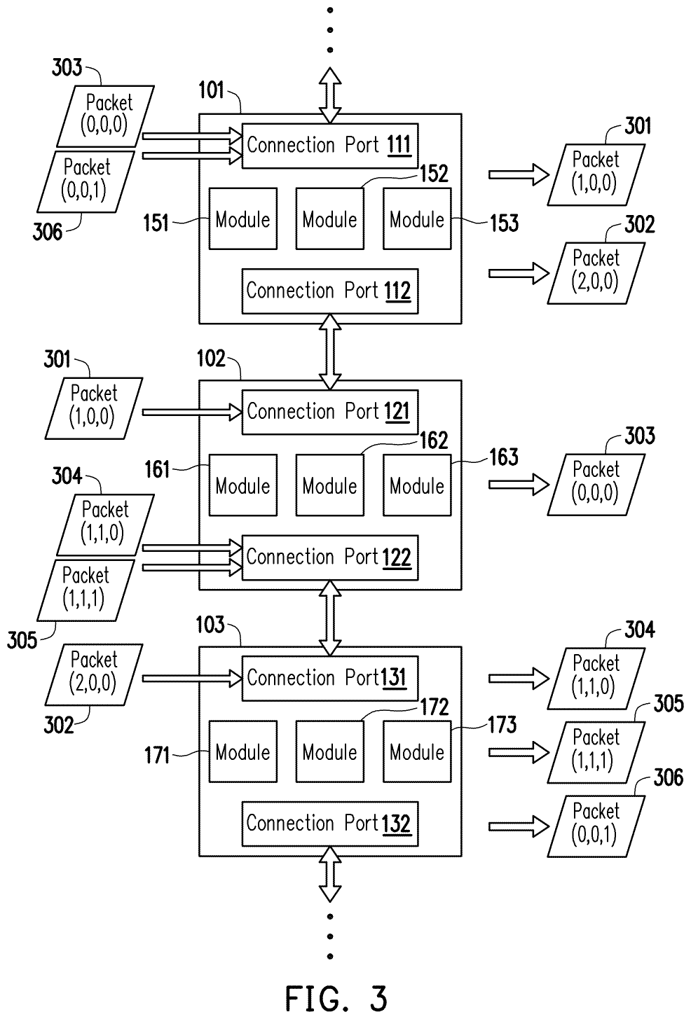

FIG. 3 is a schematic diagram of packet transmission between various FPGA devices according to an embodiment. Please refer to FIG. 3. The packets transmitted here belong to the first transmission format or the second transmission format. That is to say, the packets all have routing information. The FPGA device 101 sends packets 301 and 302. The routing information of the packet 301 is indicated as (1,0,0), and the routing information of the packet 302 is indicated as (2,0,0). The FPGA device 102 sends a packet 303. The routing information is indicated as (0,0,0). The FPGA device 103 sends packets 304 to 306. The routing information of the packet 304 is indicated as (1,1,0), the routing information of the packet 305 is indicated as (1,1,1), and the routing information of the packet 306 is indicated as (0,0,1).

Based on the routing information of the packets, the packets may be sent to specific connection ports in specific FPGA devices and received by specific modules. Specifically, the packet 301 may be transmitted to the connection port 121 in the FPGA device 102 and received by the module 161. The packet 302 may be sent to the connection port 131 in the FPGA device 103 and received by the module 171. The packet 303 may be sent to the connection port 111 in the FPGA device 101 and received by the module 151. The packet 304 may be sent to the connection port 122 in the FPGA device 102 and received by the module 161. The packet 305 may be sent to the connection port 122 in the FPGA device 102 and received by the module 162. The packet 306 may be sent to the connection port 111 in the FPGA device 101 and received by the module 152.

Although the packets 304 and 305 are transmitted to the same connection port in the same FPGA device, they are received by different modules. In the embodiment, two different packets (with different routing information) are generated respectively for different modules, and the packets are not transmitted in a broadcast manner.

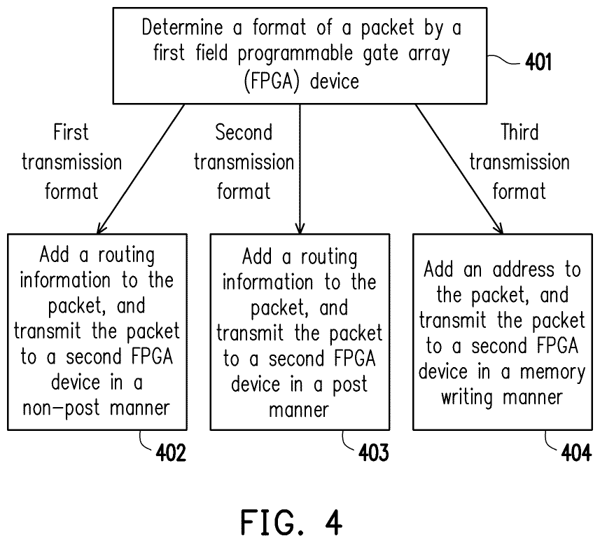

FIG. 4 is a flow chart of a communication method according to an embodiment. Please refer to FIG. 4. In step 401, the format of a packet is determined by a first FPGA device. If the format of the packet belongs to a first transmission format, in step 402, a routing information is added to the packet, and the packet is transmitted to a second FPGA device in a non-post manner. If the format of the packet belongs to a second transmission format, in step 403, a routing information is added to the packet, and the packet is transmitted to a second FPGA device in a post manner. If the format of the packet belongs to a third transmission format, in step 404, an address is added to the packet, and the packet is transmitted to a second FPGA device in a memory writing manner. When the format of the packet belongs to the first transmission format or the second transmission format, the first FPGA device may be directly electrically connected or indirectly electrically connected to the second FPGA device. When the format of the packet belongs to the third transmission format, the first FPGA device is directly electrically connected to the second FPGA device. Each step in FIG. 4 has been described in detail above and will not be repeated here. It is worth noting that each step in FIG. 4 may be implemented as multiple program codes or circuits, and the disclosure is not limited thereto. In addition, the method in FIG. 4 may be used in conjunction with the foregoing embodiments or may be used alone. In other words, other steps may also be added between each step in FIG. 4.

In the foregoing communication system and communication method, data may be transmitted between multiple FPGA devices. Since routing information are used in some transmission formats, the expansion of FPGA devices is facilitated, and packets may be sent to remote FPGA devices. In addition, the third transmission format may also provide a faster transmission speed than the conventional technology.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A communication system, comprising:
a plurality of field programmable gate array (FPGA) devices, wherein each of the FPGA devices comprises at least one connection port, and each of the FPGA devices is electrically connected to another one of the FPGA devices through the corresponding at least one connection port,
wherein the FPGA devices comprise a first FPGA device and a second FPGA device,
wherein the first FPGA device is configured to determine a format of a packet, and the format belongs to one of a plurality of transmission formats,
wherein when the format belongs to a first transmission format or a second transmission format among the transmission formats, the first FPGA device adds a routing information to the packet and transmits the packet to the second FPGA device.

2. The communication system according to claim 1, wherein the routing information comprises a bus sequence number, a device sequence number, and a function sequence number,
wherein the bus sequence number corresponds to the second FPGA device, the device sequence number corresponds to the at least one connection port of the second FPGA device, and the function sequence number corresponds to one of a plurality of modules in the second FPGA device.

3. The communication system according to claim 2, wherein the FPGA devices comprise a third FPGA device, and the third FPGA device is electrically connected between the first FPGA device and the second FPGA device,
wherein the third FPGA device receives the packet and transmits the packet to the second FPGA device based on the routing information.

4. The communication system according to claim 2, wherein a number of the at least one connection port of the second FPGA device is greater than one, and the device sequence number corresponds to one of the connection ports.

5. The communication system according to claim 1, wherein when the format belongs to the first transmission format, the first FPGA device transmits the packet in a non-post manner,
wherein when the format belongs to the second transmission format, the first FPGA device sets the packet as a vender message and transmits the packet in a post manner.

6. The communication system according to claim 1, wherein when the format belongs to a third transmission format among the transmission formats, the first FPGA device sets the packet to be transmitted to the second FPGA device in a memory writing manner.

7. The communication system according to claim 6, wherein the first FPGA device is electrically connected to the second FPGA device, the packet comprises an address, and the second FPGA device provides the packet to one of a plurality of modules in the second FPGA device based on the address.

8. A communication method adapted for a plurality of field programmable gate array (FPGA) devices, comprising:
determining a format of a packet by a first FPGA device among the FPGA devices, wherein the format belongs to one of a plurality of transmission formats, each of the FPGA devices comprises at least one connection port, and each of the FPGA devices is electrically connected to another one of the FPGA devices through the corresponding at least one connection port; and
adding a routing information to the packet and transmitting the packet to a second FPGA device among the FPGA devices by the first FPGA device when the format belongs to a first transmission format or a second transmission format among the transmission formats.

9. The communication method according to claim 8, wherein the routing information comprises a bus sequence number, a device sequence number and a function sequence number, the bus sequence number corresponds to the second FPGA device, and the device sequence number corresponds to the at least one connection port of the second FPGA device, and the function sequence number corresponds to one of a plurality of modules in the second FPGA device.

10. The communication method according to claim 9, wherein the FPGA devices comprise a third FPGA device, the third FPGA device is electrically connected between the first FPGA device and the second FPGA device, and the communication method further comprises:
receiving the packet and transmitting the packet to the second FPGA device based on the routing information by the third FPGA device.

11. The communication method according to claim 9, wherein a number of the at least one connection port of the second FPGA device is greater than one, and the device sequence number corresponds to one of the connection ports.

12. The communication method according to claim 8, further comprising:
transmitting the packet in a non-post manner by the first FPGA device when the format belongs to the first transmission format; and
setting the packet as a vender message and transmitting the packet in a post manner by the first FPGA device when the format belongs to the second transmission format.

13. The communication method according to claim 8, further comprising:
setting the packet to be transmitted to the second FPGA device in a memory writing manner by the first FPGA device when the format belongs to a third transmission format among the transmission formats.

14. The communication method according to claim 13, wherein the first FPGA device is electrically connected to the second FPGA device, the packet comprises an address, and the communication method further comprises:
providing the packet to one of a plurality of modules in the second FPGA device based on the address by the second FPGA device.
